(19) United States
(12) Patent Application Publication
(10) Pub. No.: US 2006/0209162 A1
(43) Pub. Date: Sep. 21, 2006

(54) Light emitting unit and image forming device

(76) Inventors: An-sik Choi, Suwon-si (KR); Chul-hyun Park, Seoul (KR)

Correspondence Address: STANZIONE & KIM, LLP, 919 18TH STREET, N.W., SUITE 440, WASHINGTON, DC, 20006, US

(21) Appl. No.: 11/280,260

(22) Filed: Nov. 17, 2005

(30) Foreign Application Priority Data
Mar. 17, 2005 (KR) 2005-22341

(51) Int. Cl. B41J 2/435

(52) U.S. Cl. 347/224

(57) ABSTRACT

An image forming device having an OPC to receive light and to form a latent image includes a light source part to scan the light to the OPC, a light source plate to support the light source part, a collimator lens disposed on a scanning path of the light, a lens supporting member mounted on the light source plate and having a cylinder shape to accommodate and support the collimator lens and to surround the light source part, a plurality of supporting columns projecting from a plate of the light source plate to surround the lens supporting member, and a plurality of rotating stoppers formed at a circumference surface of the lens supporting member to engage with the supporting columns in a circumferential direction. Accordingly, a light emitting unit and an image forming device can prevent an optical axis alignment and a beam diameter alignment of a collimator lens relative to a light source part from being out of line by supporting the collimator lens such that a relative position of the collimator lens with respect to the light source part is not changed. Particularly, the light emitting unit and the image forming device can prevent a position of the collimator lens from being displaced due to deflection when the collimator lens is attached to the light source part by a ultraviolet curing adhesive.

### CROSS-REFERENCE TO RELATED APPLICATIONS

This application claims the benefit under 35 U.S.C. § 119 of Korean Patent Application No. 2005-22341, filed on Mar. 17, 2005 in the Korean Intellectual Property Office, the disclosure of which is incorporated herein in its entirety by reference.

### BACKGROUND OF THE INVENTION

1. Field of the Invention

The present general inventive concept relates to a light emitting unit and an image forming device, and more particularly, to a light emitting unit and an image forming device having an improved supporting structure of a collimator lens which controls light emitted from a light source.

2. Description of the Related Art

Conventionally, an image forming device includes a feeder, an image forming unit, a fixing unit, and a discharge unit. The feeder supplies printing paper into the image forming unit, and then the image forming unit selectively coats a developer on the printing paper and forms a predetermined image. The fixing unit fixes the coated developer on the printing paper. The discharge unit receives the printing paper fixed with the developer from the fixing unit and discharges the printing paper from the image forming device.

The image forming unit comprises an opto photo-organic conductor (OPC), a light emitting unit, a developing roller, and a transferring roller. The light emitting unit scans light containing print image information to the OPC, and the exposed OPC forms a latent image. The developing roller supplies the developer to the latent image of the OPC and develops the latent image, and the transferring roller transfers a developed image formed on the OPC to the printing paper.

The light emitting unit comprises a light source module, a polygon mirror assembly, a plurality of optical units, and a frame. The light source module generates and irradiates the light, and the polygon mirror assembly changes a process direction of the light so as to face the OPC. The plurality of optical units are placed on a scanning path of the light and change a progress characteristic of the light. The frame supports the light source module, the polygon mirror assembly, and the plurality of optical units.

FIG. 1 is an exploded perspective view illustrating a light source module of a conventional image forming device, and FIG. 2 is a front view illustrating the light source module of FIG. 1. As illustrated in FIGS. 1 and 2, the light source module 40 comprises a light source part 41 to emit the light, and a collimator lens 51 to control the progress characteristic of the light emitted from the light source part 41.

The light source part 41 includes a light element 42 to emit the light corresponding to a predetermined signal and a substrate 43 to apply the predetermined signal to the light element 42. A light source plate 44 supports the light source part 41. A lens supporting member 48 of a cylinder shape supports the collimator lens 51 which is mounted on the scanning path of the light emitted from the light source part 41.

A supporting plate 45 is extended from the light source plate 44 in a perpendicular direction and includes an attaching surface 45a formed to support a partial circumference surface of the lens supporting member 48. That is, the supporting plate 45 does not support an entire circumference surface of the lens supporting member 48, and only the partial circumference surface of the lens supporting member 48 is attached to the attaching surface 45a and supported by the supporting plate 45.

Accordingly, the conventional image forming device has problems as described below.

The collimator lens 51 is not stably supported, so that a relative position of the collimator lens 51 with respect to the light source part 41 can be easily displaced. The supporting plate 45 does not support the entire circumference surface of the lens supporting member 48 supporting the collimator lens 51, but supports the partial circumference surface thereof, so that the supporting force of the supporting plate 45 is weak and the supporting plate 45 is weak against an external force. Further, a position where the lens supporting member 48 is supported by the supporting plate 45 can be easily displaced. Accordingly, the relative position of the collimator lens 51 with respect to the light source part 41 is displaced, and an optical axis alignment and a beam diameter alignment of the collimator lens 51 with respect to the light source part 41 are out of line, so that the collimator lens does not function normally.

Particularly, in a case in which the lens supporting member 48 is attached by an ultraviolet curing adhesive and supported by the supporting plate 45, the relative position of the collimator lens 51 with respect to the light source part 41 may be changed due to deflection according to curing of the ultraviolet curing adhesive. Because the ultraviolet curing adhesive is coated only on the partial circumference of the lens supporting member 48, a deflection force according to the curing of the ultraviolet curing adhesive may be unequally applied to the lens supporting member 48 in a circumferential direction. Therefore, the lens supporting member 48 is displaced and the relative position of the collimator lens 51 with respect to the light source part 41 may be displaced.

### SUMMARY OF THE INVENTION

Accordingly, the present general inventive concept provides a light emitting unit and an image forming device which prevent an optical axis alignment and a beam diameter alignment of a collimator lens relative to a light source part from being out of line by supporting the collimator lens such that a relative position of the collimator lens with respect to the light source part does not change. Particularly, the present general inventive concept provides a light emitting unit and an image forming device which prevent a position of a collimator lens from being displaced due to deflection when the collimator lens is attached to a light source part by an ultraviolet curing adhesive.

Additional aspects of the present general inventive concept will be set forth in part in the description which follows and, in part, will be obvious from the description, or may be learned by practice of the general inventive concept.

The foregoing and/or other aspects of the present general inventive concept are achieved by providing an image forming device having an opto photo-organic conductor (OPC) to receive light and to form a latent image, comprising a light source part to scan the light to the OPC, a light source plate to support the light source part, a collimator lens disposed on a scanning path of the light, a lens supporting member mounted on the light source plate and having a cylinder shape to accommodate and support the collimator lens and to surround the light source part, a plurality of supporting columns projecting from the light source plate to surround the lens supporting member, and a plurality of rotating stoppers formed in a circumference surface of the lens supporting member to engage with the supporting columns in a circumferential direction.

The supporting columns may surround the lens supporting member at equiangular intervals.

At least one of the supporting columns may comprise a pass through hole penetrating therethrough and extending in a lengthwise direction to expose an outer surface of the lens supporting member.

The image forming device may further comprise a reinforcing rib to connect the supporting columns.

At least one of the rotating stoppers may comprise an extending part extending farther than the other rotating stoppers.

The foregoing and/or other aspects of the present general inventive concept are also achieved by providing a light emitting unit having a polygon mirror assembly to change a progress direction of light and a frame to support a polygon mirror assembly, comprising a light source part to scan the light to the polygon mirror assembly, a light source plate to support the light source part and supported by the frame, a collimator lens disposed on a scanning path of the light, a lens supporting member mounted on the light source plate and having a cylinder shape to accommodate and support the collimator lens and surround the light source part, a plurality of supporting columns projecting from the light source plate to surround the lens supporting member, and a plurality of rotating stoppers formed in a circumference surface of the lens supporting member to engage with the supporting columns in a circumferential direction.

The supporting columns may surround the lens supporting member at equiangular intervals.

At least one of the supporting columns may comprise a pass through hole penetrating therethrough and extending in a lengthwise direction to expose an outer surface of the lens supporting member.

The light emitting unit may further comprise a reinforcing rib to connect the supporting columns.

At least one of the rotating stoppers may comprise an extending part extending farther than the other rotating stoppers.

The foregoing and/or other aspects of the present general inventive concept are also achieved by providing a light emitting unit, comprising a light source to emit light, a collimator lens to direct the emitted light in a predetermined direction, a lens supporting unit to support the collimator lens at a predetermined distance from the light source, and a position supporting unit to surround the lens supporting unit to control a range of movement of the lens supporting unit with respect to the light source.

The foregoing and/or other aspects of the present general inventive concept are also achieved by providing a light emitting unit, comprising a light source to generate light, a collimator lens to collimate the light, and a lens supporting unit including a housing to support the collimator lens and a housing positioning unit including a plurality of columns surrounding the housing and attached to the housing to prevent the housing from moving from a desired position.

The foregoing and/or other aspects of the present general inventive concept are also achieved by providing a method of manufacturing a light source module of a light source unit, the method comprising pressfitting a light source into a hole formed in a plate, accommodating a lens supporting member supporting a collimator lens in a plurality of columns such that the columns are disposed around a circumference of the lens supporting member, adjusting the lens supporting member to a desired position within the plurality of columns, and adhering the lens supporting member at the desired position within the plurality of columns.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is an exploded perspective view illustrating a light source module of a conventional image forming device;

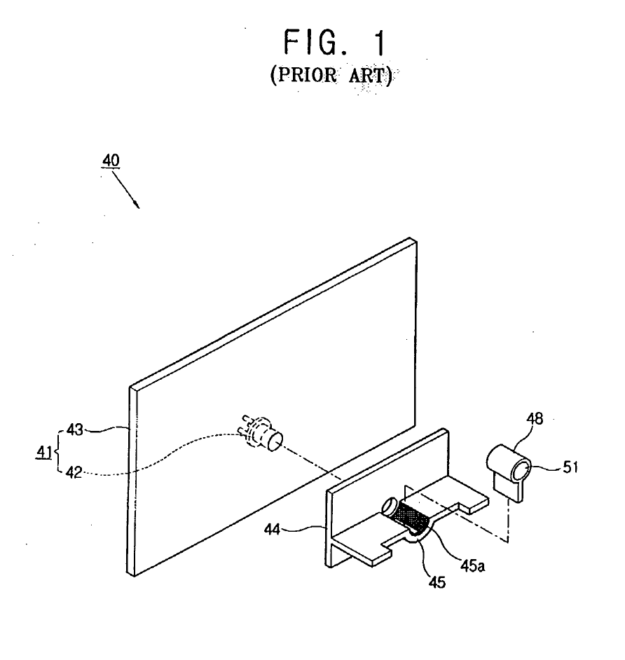

FIG. 2 is a front view illustrating the light source module of FIG. 1;

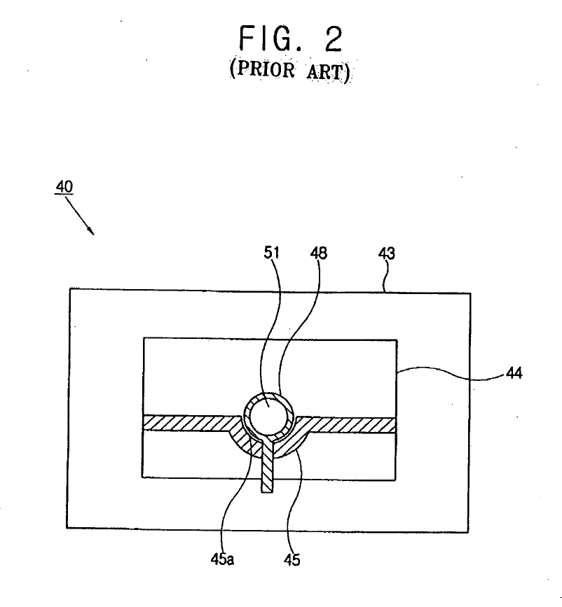

FIG. 3 is a diagram schematically illustrating an image forming device according to an embodiment of the present general inventive concept;

FIG. 4 is a diagram schematically illustrating a light emitting unit of the image forming device of FIG. 3;

FIG. 5 is an exploded perspective view illustrating a light source module of the image forming device of FIG. 3; and

FIG. 6 is a front view illustrating the light source module of the image forming device of FIG. 3.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to like elements throughout. The embodiments are described below in order to explain the present general inventive concept while referring to the figures.

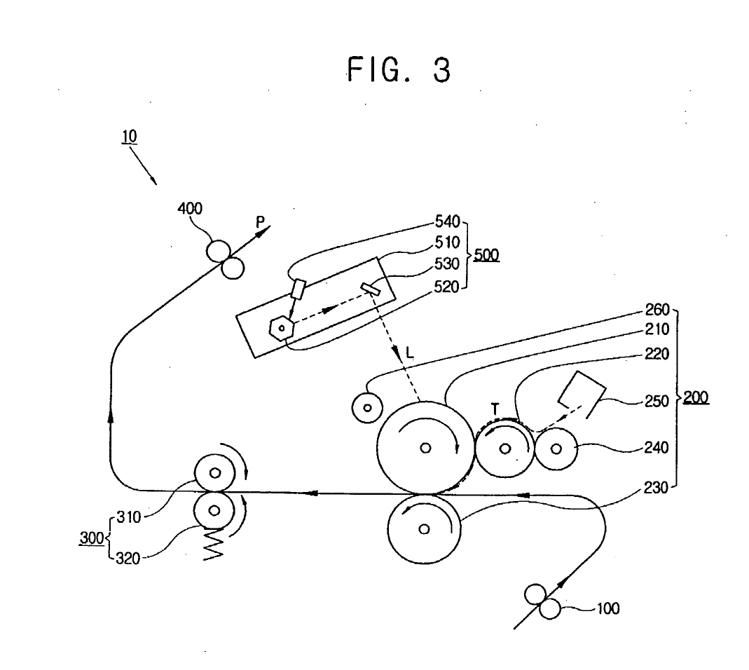

FIG. 3 is a diagram schematically illustrating an image forming device 10 according to an embodiment of the present general inventive concept. Referring to FIG. 3, the image forming device 10 includes a feeder 100, an image forming unit 200, a fixing unit 300, and a delivery unit 400. The feeder 100 feeds printing paper P into the image forming unit 200. The image forming unit 200 selectively coats a developer T onto the printing paper P by using a potential difference and then forms a desired image on the printing paper P. The fixing unit 300 fixes the developer T on the printing paper P. The delivery unit 400 receives the printing paper P from the fixing unit 300 and discharges the printing paper P from the image forming device 10.

The image forming unit 200 comprises an opto photo-organic conductor (OPC) 210, a light emitting unit 500, an electric charging roller 260, a developing roller 220, and a transferring roller 230. The OPC 210 forms an image thereon by rotating and passing an image forming surface thereof by the electric charging roller 260, the light emitting unit 500, the developing roller 220, and the transferring roller 230 in turn. If the electric charging roller 260 electrifies the image forming surface of the OPC 210 as a negative charge, the light emitting unit 500 emits light L to the OPC 210 and forms a latent image on the OPC 210. The developing roller 220 selectively coats the developer T on the latent image formed on the OPC 210. A supplying roller 240 receives the developer T from a developer store part 250 and supplies the developer T to the developing roller 220 to be used to coat the latent image formed on the image forming surface of the OPC 210. The transferring roller 230 transfers the developer T coated on the latent image formed on the OPC 210 to the printing paper P, which passes between the OPC 210 and the transferring roller 230. Accordingly, the image forming unit 200 coats the developer T on the printing paper P and forms the desired image as described above.

The fixing unit 300 comprises a heating roller 310 and a pressing roller 320 which rotate in opposite directions with respect to each other while passing the printing paper P therebetween. The heating roller 310 comprises a heating unit (not shown) and the pressing roller 320 comprises a pressing unit. When the fixing unit 300 receives the printing paper P coated with the developer T from the image forming unit 200, the heating roller 310 and the pressing roller 320 respectively heat and pressurize the printing paper P. Accordingly, the developer T is heated and pressed and fixed on the printing paper P such that a print image is formed on the printing paper.

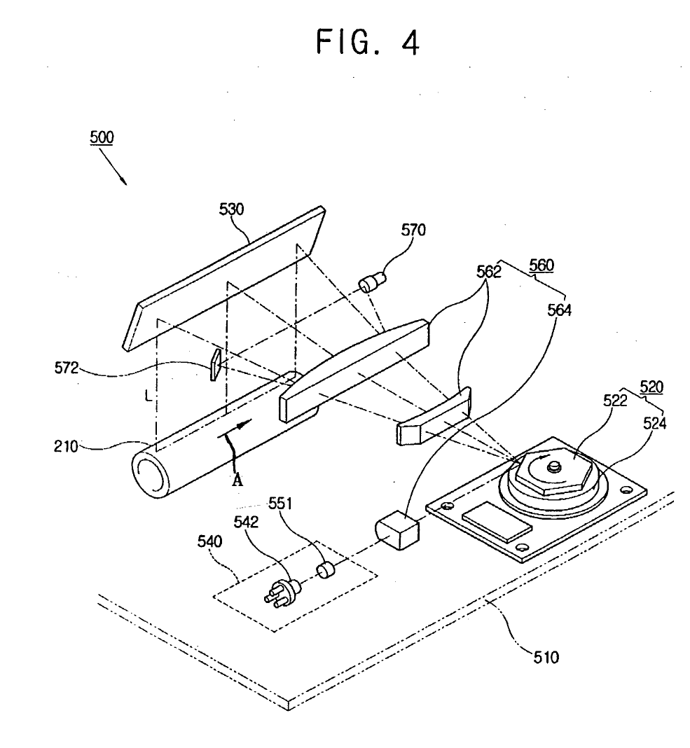

FIG. 4 is a diagram schematically illustrating the light emitting unit 500 of the image forming device 10 of FIG. 3. Referring to FIGS. 3 and 4, the light emitting unit 500 comprises a light source module 540, a polygon mirror assembly 520, a reflecting mirror 530, a plurality of optical units 560, and a frame 510 to support elements thereof. The light emitting unit 500 emits the light L, which includes desired printing image information, to the OPC 210 to form the latent image on the OPC 210.

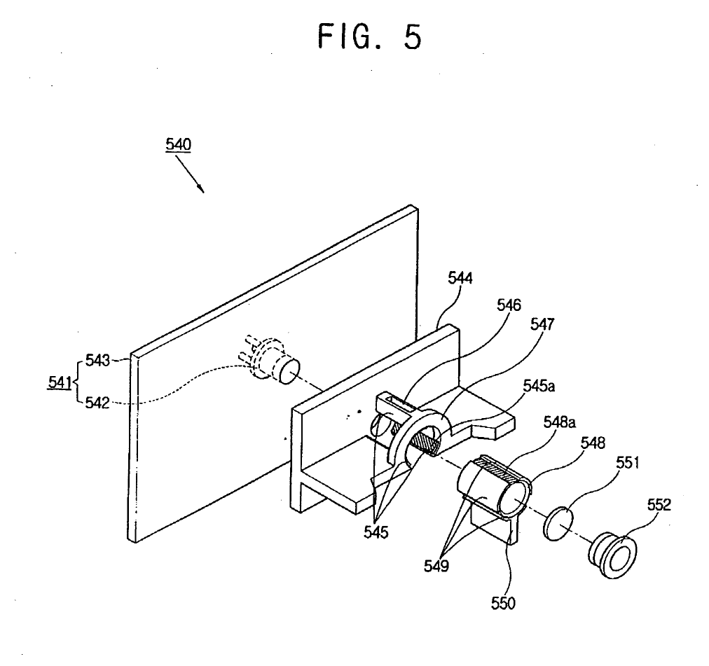

The light source module 540 comprises a light source part 541 (see FIG. 5) to generate and emit the light L and a collimator lens 551 to adjust the light L to be parallel with respect to a predetermined light axis. The polygon mirror assembly 520 comprises a polygon mirror 522 having a plurality of reflecting surfaces and a driving part 524 to rotate the polygon mirror 522 at a uniform high speed. The plurality of optical units 560 comprises a cylindrical lens 564 and a scanning lens combination 562.

The cylindrical lens 564 is interposed between the light source module 540 and the polygon mirror 522, and converges the light L emitted from the light source module 540 in a sub-scanning direction. The polygon mirror 522 is rotated by the driving part 524 at the uniform high speed while receiving the light L passing through the cylindrical lens 564, and reflects the received light L to form a predetermined angle of view. The scanning lens combination 562 converges the light L emitted from the polygon mirror 522 in a main scanning direction (see arrow A of FIG. 4). The main scanning direction is a direction in which the light L is scanned along the OPC 210. The reflecting mirror 530 reflects the light L passing through the scanning lens 562 in a predetermined direction toward the OPC 210 to form the latent image on the OPC 210. Accordingly, as the polygon mirror 522 rotates, the light L is scanned along the OPC 210 in the main scanning direction. A synchronous mirror 572 directs a portion of the light L passing through the scanning lens combination 562 toward a light sensor 570, which synchronizes the light L.

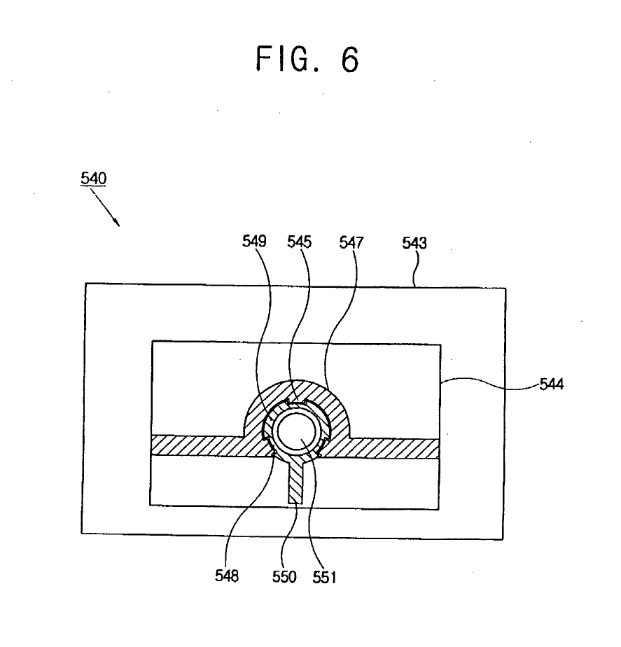

FIG. 5 is an exploded perspective view illustrating the light source module 540 of the image forming device 10 of FIG. 3, and FIG. 6 is a front view illustrating the light source module 540 of the image forming device of FIG. 3. Referring to FIGS. 3-6, the light source module 540 comprises the light source part 541, a light source plate 544, the collimator lens 551, a lens supporting member 548, a plurality of supporting columns 545, and a plurality of rotating stoppers 549. The light source module 540 scans light toward the polygon mirror 522 (FIG. 4).

The light source part 541 includes a light source element 542 to generate a predetermined light corresponding to an input signal, and a substrate 543 to receive printing information input from an external source and to apply the received printing information to the light source element 542. The light source element 542 may be a laser diode to generate a laser beam. Further, the light source element 542 may be any light emitting element capable of generating the light according to the input signal, such as an LED or the like.

The light source plate 544 supports the light source part 541. For example, the light source element 542 of the light source part 541 can be pressfitted into a hole formed in the light source plate 544. The light source plate 544 can be supported by the frame 510 of the light emitting unit 500.

The collimator lens 551 is mounted on the scanning path of the light emitted from the light source part 541 and adjusts a progress characteristic of the light. The collimator lens 551 makes the light parallel in the main scanning direction and the sub scanning direction.

The collimator lens 551 is supported by the lens supporting member 548 to be spaced apart from the light source part 541 by a predetermined distance. The lens supporting member 548 has a cylinder shape and is disposed on the light source plate 544 and extends from the light source plate 544 in a direction in which the light source part 541 directs the light. An aperture 552 press fits the collimator lens 551 into the lens supporting member 548 and prevents the collimator lens 551 from being separated from the lens supporting member 548.

The supporting columns 545 project from the light source plate 544 and are disposed to surround the lens supporting member 548. The supporting columns 545 surround an entire circumference surface of the lens supporting member 548 to accommodate and support the lens supporting member 548. The entire circumference surface of the lens supporting member 548 is supported by the supporting columns 545 such that the lens supporting member 548 can resist an external force which may be applied thereto. Accordingly, a relative position of the collimator lens 551 with respect to the light source part 541 is stably maintained.

In a case in which an ultraviolet curing adhesive is coated on both an outer surface 548a of the lens supporting member 548 and inner surfaces 545a of the supporting columns 545, the supporting columns 545 support the lens supporting member 548 to prevent the lens supporting member 548 from being deflectably displaced in any direction due to a deflective force caused by curing of the ultraviolet curing adhesive. The plurality of the supporting columns 545 uniformly support the lens supporting member 548 along a circumferential direction of the lens supporting member 548 such that change of a position of the lens supporting member 548 is minimized. Accordingly, the supporting columns 545 prevent an optical axis alignment or a beam diameter alignment of the collimator lens 551 from being out of line. The supporting columns 545 may surround the lens supporting member 548 at equiangular intervals, thereby maximizing uniformity of a supporting force relative to the circumferential direction, and also minimizing the deflection caused by the curing of the ultraviolet curing adhesive.

The inner surface 545a of each supporting column 545 can be spaced apart from the outer surface 548a of the lens supporting member 548 by a predetermined interval. Accordingly, the lens supporting member 548 can move within the predetermined interval when the lens supporting member 548 is in a state of being accommodated by the supporting columns 545. The optical axis or the beam diameter of the collimator lens 551 can be controlled by moving the position of the lens supporting member 548 within the predetermined interval in the state in which the lens supporting member 548 is accommodated by the supporting columns 545.

The supporting columns 545 are spaced apart from each other and support the lens supporting member 548. The lens supporting member 548 is exposed between the supporting columns 545 even in the state in which the lens supporting member 548 is accommodated by the supporting columns 545. To attach the lens supporting member 548 to the supporting columns 545 by the ultraviolet curing adhesive, the lens supporting member 548 is accommodated by the supporting columns 545, and then the ultraviolet curing adhesive can be coated on the outer surface 548a of the lens supporting member 548 and the inner surfaces 545a of the supporting columns 545 through spaces between the supporting columns 545. The position of the lens supporting member 548 can then be adjusted within the supporting columns 545 to control the optical axis and the beam diameter of collimator lens 551, and the ultraviolet curing adhesive coated onto the outer surface 548a of the lens supporting member 548 and the inner surfaces 545a of the supporting columns 545 can then be cured by ultraviolet light.

At least one of the supporting columns 545 can comprise a pass through hole 546 formed through the supporting column 545 and extending in a lengthwise direction such that the outer surface 548a of the lens supporting member 548 is exposed through the pass through hole 546. In the case in which the lens supporting member 548 is attached to the supporting columns 545 by the ultraviolet curing adhesive, the pass through hole 546 exposes the outer surface 548a of the lens supporting member 548 coated with the ultraviolet curing adhesive such that the exposed outer surface 548a of the lens supporting member 548 can easily be cured by the ultraviolet light. The pass through hole 546 may be formed in the supporting column 545 mounted facing a direction from which the ultraviolet light is emitted by an ultraviolet scanner (not shown).

The rotating stoppers 549 are formed around the circumference of the outer surface 548a of the lens supporting member 548 to engage with the supporting columns 545 in the circumferential direction. The rotating stoppers 549 also extend outwardly in a radial direction from the outer surface 548a of the lens supporting member 548 and form stoppers in the circumferential direction. Each rotating stopper 549 engages between two of the supporting columns 545 and prevent the lens supporting member 548 from deflection due to rotating with respect to the supporting columns 545. Accordingly, the rotating stoppers 549 engage with adjacent supporting columns 545 to prevent the optical axis alignment or the beam diameter alignment of the collimator lens 551 from being out of line.

The rotating stoppers 549 are disposed at portions of the outer surface 548a of the lens supporting member 548, which are not aligned with the supporting columns 545, and extend between the supporting columns 545. In the case in which the supporting columns 545 are disposed at equiangular intervals, the rotating stoppers 549 are also disposed at equiangular intervals.

The rotating stoppers 549 can be formed to be spaced apart from the supporting columns 545 by a predetermined gap when the lens supporting member 548 is accommodated by the supporting columns 545. Accordingly, the position of the lens supporting member 548 can be adjusted in a rotating direction with respect to the supporting columns 545, as well as in an axis direction or a radial direction when the lens supporting member 548 is accommodated in the supporting columns 545, to thereby control the optical axis or the beam diameter of the collimator lens 551. The rotating stoppers 549 can be supported by the supporting columns 545 such that the lens supporting member 548 can slide in the axis direction by sliding the rotating stoppers 549 against the supporting columns 545. Accordingly, aligning the beam diameter of the collimator lens 551 can easily be accomplished.

At least one of the rotating stoppers 549 can comprise an extending part 550 extending farther from the outer surface 548a of the lens supporting member 548 than the other rotating stoppers 549. The extending part 550 can be used to control the lens supporting member 548 in the state in which the lens supporting member 548 is accommodated and supported by the supporting columns 545. That is, the extending part 550 can easily be held using a holding unit, such as a jig, etc., and the optical axis and the beam diameter of the collimator lens 551 can be adjusted, the ultraviolet curing adhesive can be coated in the inner surface 545a of the supporting columns 545 or the outer surface 548a of the lens supporting member 548, or the ultraviolet light can be scanned at the area coated with the ultraviolet curing adhesive while holding the extending part 550.

A reinforcing rib 547 connects the supporting columns 545 to each other and reinforces the supporting columns 545 to securely accommodate the lens supporting member 548. The reinforcing rib 547 can connect an end of each supporting column 545 in a circle shape. Alternatively, the reinforcing rib 547 may connect a middle portion or a different position of the supporting columns 545, and connect and reinforce the supporting columns 545 in a different shape. The reinforcing rib 547 may be formed with plural ribs and connect various areas of the supporting columns 545.

The light source plate 544, the supporting columns 545 and the reinforcing rib 547 can be formed by injection molding, integrally formed in a single body, or integrally formed by injection molding. Further, the lens supporting member 548 and the rotating stoppers 549 can be formed by injection molding, integrally formed in the single body, or integrally formed by injection molding.

A manufacturing process of the light source module 540 according to an embodiment of the present general inventive concept using the ultraviolet curing adhesive will be described below with reference to FIGS. 5 and 6. As illustrated in FIGS. 5 and 6, the light element 542 of the light source part 541 is pressfitted into the light source plate 544, and the collimator lens 551 is pressfitted into the lens supporting member 548 by the aperture 552. The lens supporting member 548 is then accommodated and supported by the supporting columns 545.

The process of accommodating and supporting the lens supporting member 548 in the supporting columns 545 will be described as follows. The ultraviolet curing adhesive can be coated on the outer surface 548a of the lens supporting member 548, and then the lens supporting member 548 is accommodated in the supporting columns 545. A user then holds the extending part 550 and adjusts a position of the lens supporting member 548 within the supporting columns 545, thereby adjusting the optical axis and the beam diameter of the collimator lens 551. Accordingly, the lens supporting member 548 is supported by the supporting columns 545 as the ultraviolet curing adhesive is cured by the ultraviolet light, which is projected along the outer surface 548a of the lens supporting member 548 between the supporting columns 545 or along the length of and through the pass through hole 546.

Alternatively, the lens supporting member 548 can be accommodated in the supporting columns 545, and then the lens supporting member 548 is adjusted to align the collimator lens 551. Next, the ultraviolet curing adhesive is coated on the outer surface 548a of the lens supporting member 548 or the inner surfaces 545a of the supporting columns 545 between the supporting columns 545, and the ultraviolet light is scanned, thereby attaching the lens supporting member 548 to the supporting columns 545. The ultraviolet curing adhesive may be coated on the outer surface 548a of the lens supporting member 548 or the inner surfaces 545a of the supporting columns 545 before the lens supporting member 548 is adjusted to align the collimator lens 551

The light source module 540 as described above can stably support the lens supporting member 548. The entire circumference surface of the lens supporting member 548 is supported by the supporting columns 545, and the rotating stoppers 549 engage with the supporting columns 545, thereby minimizing change of the radial direction, the axis direction, and the rotating direction of the lens supporting member 548. The deflection according to the curing of the ultraviolet curing adhesive is prevented from changing the relative position of the collimator lens 551 with respect to the light source part 541. Accordingly, the light source module 540 prevents the optical axis alignment and the beam diameter alignment of the collimator lens 551 from being out of line, thereby minimizing quality deterioration of the light source module 540.

An image forming device according to the present general inventive concept may be applied to an electro photographic printer, an electro photographic duplicator, an electro photographic facsimile, an electro photographic duplicator, an electro photographic multi-function printer, etc. A light emitting unit according to the present general inventive concept may be applied to the image forming device or such a similar device.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming device having an opto photo-organic conductor (OPC) to receive light and to form a latent image, comprising:
a light source part to scan the light to the OPC;
a light source plate to support the light source part;
a collimator lens disposed on a scanning path of the light;
a lens supporting member mounted on the light source plate and having a cylinder shape to accommodate and support the collimator lens and to surround the light source part;
a plurality of supporting columns projecting from the light source plate to surround the lens supporting member; and
a plurality of rotating stoppers formed at a circumference surface of the lens supporting member to engage with the supporting columns in a circumferential direction.

2. The image forming device according to claim 1, wherein the supporting columns surround the lens supporting member at equiangular intervals.

3. The image forming device according to claim 1, wherein at least one of the supporting columns comprises a pass through hole penetrating therethrough to expose an outer surface of the lens supporting member.

4. The image forming device according to claim 1, further comprising a reinforcing rib to connect the supporting columns.

5. The image forming device according to claim 1, wherein at least one of the rotating stoppers comprises an extending part extending farther from the circumference surface of the lens supporting member than the other rotating stoppers.

6. The image forming device according to claim 1, wherein the light source plate and the supporting columns are integrally formed.

7. The image forming device according to claim 1, wherein the lens supporting member and the rotating stoppers are integrally formed.

8. The image forming device according to claim 1, further comprising an aperture to pressfit the collimator lens into the lens supporting member.

9. A light emitting unit having a polygon mirror assembly to change a progress direction of light and a frame to support a polygon mirror assembly, comprising:
a light source part to scan the light to the polygon mirror assembly;
a light source plate to support the light source part and supported by the frame;
a collimator lens disposed on a scanning path of the light;
a lens supporting member mounted on the light source plate and having a cylinder shape to accommodate and support the collimator lens and to surround the light source part;
a plurality of supporting columns projecting from the light source plate to surround the lens supporting member; and
a plurality of rotating stoppers formed at a circumference surface of the lens supporting member to engage with the supporting columns in a circumferential direction.

10. The light emitting unit according to claim 9, wherein the supporting columns surround the lens supporting member at equiangular intervals.

11. The light emitting unit according to claim 10, wherein at least one of the supporting columns comprises a pass through hole penetrating therethrough to expose an outer surface of the lens supporting member.

12. The light emitting unit according to claim 9, further comprising a reinforcing rib to connect the supporting columns.

13. The light emitting unit according to claim 9, wherein at least one of the rotating stoppers comprises an extending part extending farther from the circumference surface of the lens supporting member than the other rotating stoppers.

14. A method of manufacturing a light source module of a light source unit, the method comprising:
pressfitting a light source into a hole formed in a plate;
accommodating a lens supporting member supporting a collimator lens in a plurality of columns such that the columns are disposed around a circumference of the lens supporting member;
adjusting the lens supporting member to a desired position within the plurality of columns; and
adhering the lens supporting member at the desired position within the plurality of columns.

15. The method according to claim 14, wherein the accommodating of the lens supporting member in the plurality of columns comprises providing stopper portions protruding from the lens supporting member and between the columns to limit the rotation of the lens supporting member with respect to the plurality of columns.

16. The method according to claim 14, wherein the adhering of the lens supporting member at the desired position within the plurality of columns comprises:
coating at least one of an outer surface of the lens supporting member and inner surfaces of the plurality of columns with an ultraviolet curing adhesive; and
curing the ultraviolet curing adhesive.

17. The method according to claim 16, wherein the curing of the ultraviolet adhesive comprises scanning ultraviolet light through a hole formed in at least one of plurality of columns.

18. The method according to claim 16, wherein the adhering of the lens supporting member at the desired position within the plurality of columns further comprises:
controlling the lens supporting member to remain in the desired position during the curing of the ultraviolet curing adhesive.
